(19) United States
(12) Patent Application Publication
(10) Pub. No.: US 2012/0084068 A1
(43) Pub. Date: Apr. 5, 2012

(54) Incorporation of Uncertainty in Simulation Analysis

(75) Inventors: Steven M. Smith, Centerville, UT (US); Cynthia Furse, Salt Lake City, UT (US)

(73) Assignee: University of Utah Research Foundation, Salt Lake City, UT (US)

(21) Appl. No.: 12/895,525

(22) Filed: Sep. 30, 2010

(51) Int. Cl. G06G 7/62

(52) U.S. Cl. 703/17

(57) ABSTRACT

A computing device simulates a test system by defining parameter values to be used to populate certain modeling formulas defining the test system. The defined parameter values correspond to one of the many points defining a domain in which the test system is to be simulated. The simulation iteratively solves the modeling formulas for each unit of the test system model space for each point in the domain in which the test system is simulated. Results for the subjects of interest are calculated at each iteration using the populated modeling formulas. A variance of the subjects of interest is also calculated at each iteration using a correlation coefficient obtained for the subjects of interest. The iterations of defining the parameter values and calculating the value and variance of the subjects of interest in the test system model space continues until all points in the domain have been simulated.

### TECHNICAL FIELD

The present disclosure relates, in general, to simulation analysis, and, more particularly, to incorporating uncertainty into simulation analysis.

### BACKGROUND

Simulation analysis is used in a wide variety of applications, such as the simulation of technology for performance optimization, safety engineering, testing, training, education, and the like. It is also used for scientific modeling of natural or human systems in order to gain insight into their functioning or used to estimate the eventual real effects of alternative conditions and courses of action on such systems. It may also often be used when operations of the real system cannot be engaged, either because it is not accessible or may be dangerous or unacceptable to engage. Such simulation analyses are generally performed using software or firmware executed on one or more general purpose computers or on special purpose computers or devices as the complexity of these systems, and the calculations used to simulate these systems, make human calculation essentially useless for any meaningful results.

In setting up any given simulation, mathematical formulas are developed that attempt to provide highly accurate models of the operation of the system to be simulated. Most systems of interest have a complex combination of parameters that the modeling formulas will use for simulating the results of system operation. Systems may be modeled in the time domain or frequency domain depending on what the intended analysis may be. In the time domain, one example of a modeling method is the finite-difference time-domain (FDTD) method. The FDTD method is often used to model wave-related phenomena, such as electromagnetic wave interactions. Another time domain method, computation fluid dynamics (CFD), uses numerical methods and algorithms to solve and analyze problems that involve fluid flows. Time domain methods generally simulate the test system over a period of time. Finite element simulations are also sometimes run in the time domain to simulate movement of machines or structures. Therefore, the modeling equations will be run using the various parameters for each point in space of the defined test system where each iteration of the test system simulation is performed at each instant of time within the tested period of time. Thus, the simulation of the underlying test system will not only generally include multiple iterations, where each iteration corresponds to the specific tested point in time, but will also include multiple sub-iterations, where the modeling equations are solved for each point in space of the defined test system. The resulting time domain simulation will illustrate the conditions of the tested system at each point in space of that tested system and will present those conditions for every point in time of the tested time period, much like the frames of a film presenting a motion picture.

One example of a frequency domain modeling method is the finite-difference frequency domain (FDFD) method. The FDFD is similar to the FDTD method except for simulating the underlying test system at each frequency in a tested band of frequencies. The FDFD is also used in modeling electromagnetic wave interactions. The basic process for simulating the test system using the FDFD is similar to the basic process of simulation with the FDTD method except that the simulation is performed over a band of different frequencies, as opposed to a window of time. There are many other different types of computational modeling methods and techniques that may be used in simulating various different systems for analysis.

In performing the simulation, most modeling techniques will arrive at a particular determinative result based on the particular set of parameters used in the model. This determinative result may be an expected average value or possibly a more exact value. However, most real world systems include an element of uncertainty that may cause the actual, real world result to differ, whether slightly or substantially, from the simulated result. For example, in a CFD analysis of fluid flowing through a porous geological formation, variations in the size or shape of the pores may have a substantial influence on the resulting flow dynamics of the fluid. Therefore, a simulation result that does not account for this variation may be substantially different from the real world result. In another type of simulation analysis, FDTD methods are used to simulate radio wave absorption by the human body caused by use of a particular cell phone design. For health and safety reasons, regulatory agencies set maximum allowable electromagnetic energy absorption rates for cell phones. Therefore, cell phone designers generally simulate various test designs to determine whether the designs will meet these regulations. In simulating this biological system, the electromagnetic waves propagate at a known, determinative rate. However, the amount of electromagnetic energy absorbed by a user's head will vary widely based on the size and shape of the user's head, the thickness of the ear, the variability in tissue properties, and the like. Using average values for these parameters in a typical FDTD simulation will yield a relatively accurate average result. However, in real world usage, it is possible that there may be users who absorb more or less electromagnetic energy than the standards allow because of the added uncertainty in the real world systems. Determining if such cases exist could be important for some applications.

Accounting for these uncertainties during simulation analysis often leads to even more complicated modeling and calculations. For example, one common solution used to account for the uncertainty and variability present in various systems is by adding a Monte Carlo analysis to the underlying simulation. The Monte Carlo method or analysis is a computational algorithm that may be used in statistical analysis to analyze uncertainty. These elements of uncertainty may be characterized as statistical variations of some of the particular properties making up the underlying test system. The Monte Carlo method generally uses randomly generated inputs to simulate the process of sampling the operations of the underlying test system from an actual random population. The Monte Carlo method will often define one or more sets of possible inputs for all or a selected number of parameters defining the system model to be simulated. The method will then run the simulation using inputs randomly selected from the particular domains for the parameters of the system model. In order to obtain an adequate sampling, the method will be run repeatedly, often running in the thousands and tens of thousands of repetitions, each testing a randomly sampled input. The data from all of these simulations are then tabulated and post-processed to determine the mean or first moment and the variance or first central moment. While each single simulation may take several hours to complete, the entire Monte Carlo process, running thousands of repetitions, could take days or even weeks to complete. Adding this amount of time and processing cost to a simulation analysis greatly increases the overall cost of the simulation analysis and is actually a deterrent to accounting for uncertainty in the simulation analysis of many systems.

Additional types of simulations in use for models with statistically varying properties include the Stochastic Finite Element Method (SFEM), perturbation methods, and the like. SFEM is a combination of deterministic FEM using uncertainties in the input parameters. SFEM uses various methods for simulating the statistical variations of the underlying test environment including Monte Carlo methods, perturbation, Neumann expansion, polynomial chaos expansion, and the like. Perturbation methods are generally based on Taylor series approximations and are usually low in computational costs. However, accuracy of such perturbation methods is generally acceptable only for small perturbations.

### BRIEF SUMMARY

Various aspects of the present disclosure are directed to accounting for uncertainty in simulations of test systems. The simulations include iterative computations that calculate for various subjects of interest in the underlying test systems. The iterations are made over the domain of the simulation. Time domain or frequency domain simulations would provide for time-based or frequency-based iterative calculations. For each iteration, parameter values are defined for the different statistical variables of the modeling formulas. Those values are often selected or defined for the particular iteration point from a set of statistical values. For example, for the particular instant in time being tested, for time domain simulations, or the particular frequency in frequency domain simulations. The modeling formulas are solved for the subject of interest at each part of the test model space for that particular iteration point. In addition to solving for the value of the subject of interest, the variance of the subject of interest is also calculated at each part of the test model space for that particular iteration point. The variance is calculated using, at least in part, a correlation coefficient that reflects the conditions of the test space model. The correlation coefficient may be determined either before the simulation begins or also determined iteratively throughout the simulation process. The correlation coefficient may be based on the various conditions of the test space model or may also simply be an estimate entered by a user running the simulation. The simulation will continue iterating through each point of the simulation domain calculating a value and variance of the subject of interest.

Additional representative aspects of the present disclosure are directed to a method of simulating a test system in a computing device. The method includes executing, by a processor, a simulation application stored on a memory coupled to the processor. The executing simulation application establishes a simulation environment in the computing device. The method also includes receiving input defining one or more parameter values for populating one or more modeling formulas defining the test system, the defined parameter values corresponding to one of the points defining a domain in which the test system is to be simulated. The method further includes obtaining a correlation coefficient for one or more subjects of interest in the test system, calculating a result for the subjects of interest using the populated modeling formulas, calculating a variance of the subjects of interest using at least the correlation coefficient, and repeating the receiving, the calculation of the result, and the calculation of the variance for each subsequent point of the domain.

Still further representative aspects of the present disclosure are directed to a computer program product to simulate a test system in a computing device. The computer program product includes a computer-readable medium having program code recorded thereon. The program code includes code to establish a simulation environment in the computing device and code to receive input defining one or more parameter values for populating one or more modeling formulas defining the test system. The defined parameter values correspond to one of the points defining a domain in which the test system is to be simulated. The program code also includes code to obtain a correlation coefficient for one or more subjects of interest in the test system, code to calculate a result for the subjects of interest using the populated modeling formulas, code to calculate a variance of the subjects of interest using at least the correlation coefficient, and code to repeat execution of the program code to receive input, the program code to calculate the result, and the program code to calculate the variance for each subsequent point of the domain.

Still further representative aspects of the present disclosure are directed to a computing device configured to simulate a test system. The computing device includes at least one processor and a memory coupled to the processor. The processor is configured to receive input defining one or more parameter values for populating one or more modeling formulas defining the test system. The defined parameter values correspond to one of the points defining a domain in which the test system is to be simulated. The processor is further configured to obtain a correlation coefficient for one or more subjects of interest in the test system, to calculate a result for the subjects of interest using the populated modeling formulas, to calculate a variance of the subjects of interest using at least the correlation coefficient, and to repeat the receiving, the calculating the result, and the calculating the variance for each subsequent point of the domain.

The foregoing has outlined rather broadly the features and technical advantages of the present disclosure in order that the detailed description that follows may be better understood. Additional features and advantages will be described hereinafter which form the subject of the claims of this disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the present disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 is a block diagram illustrating a computing system configured according to one embodiment of the present disclosure.

FIG. 2 is a functional block diagram illustrating example blocks executed to implement one embodiment of the present disclosure.

FIG. 3 is a functional block diagram illustrating example steps executed to implement one embodiment of the present disclosure.

FIG. 4 is a block diagram illustrating a test system model space for simulation according to one embodiment of the present disclosure.

FIG. 5A is a graphical plot illustrating an example normalized error in a simulation according to one embodiment of the present disclosure.

FIG. 5B is a graphical plot illustrating another example normalized error in a simulation according to one embodiment of the present disclosure.

FIG. 6 is a functional block diagram illustrating example blocks executed to implement one embodiment of the present disclosure.

FIG. 7 illustrates an exemplary computer system which may be employed to implement the various aspects and embodiments of the present disclosure.

### DETAILED DESCRIPTION

In the preceding detailed description, numerous specific details were set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description were presented in terms of algorithms or symbolic representations of operations on data bits or binary digital signals stored within a computing system memory, such as a computer memory. These algorithmic descriptions or representations are examples of techniques used by those of ordinary skill in the art to convey the substance of their work to others skilled in the art.

An algorithm is here, and generally, considered to be a self-consistent sequence of operations or similar processing leading to a desired result. In this context, operations or processing involve physical manipulation of physical quantities. Typically, although not necessarily, such physical quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like, refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

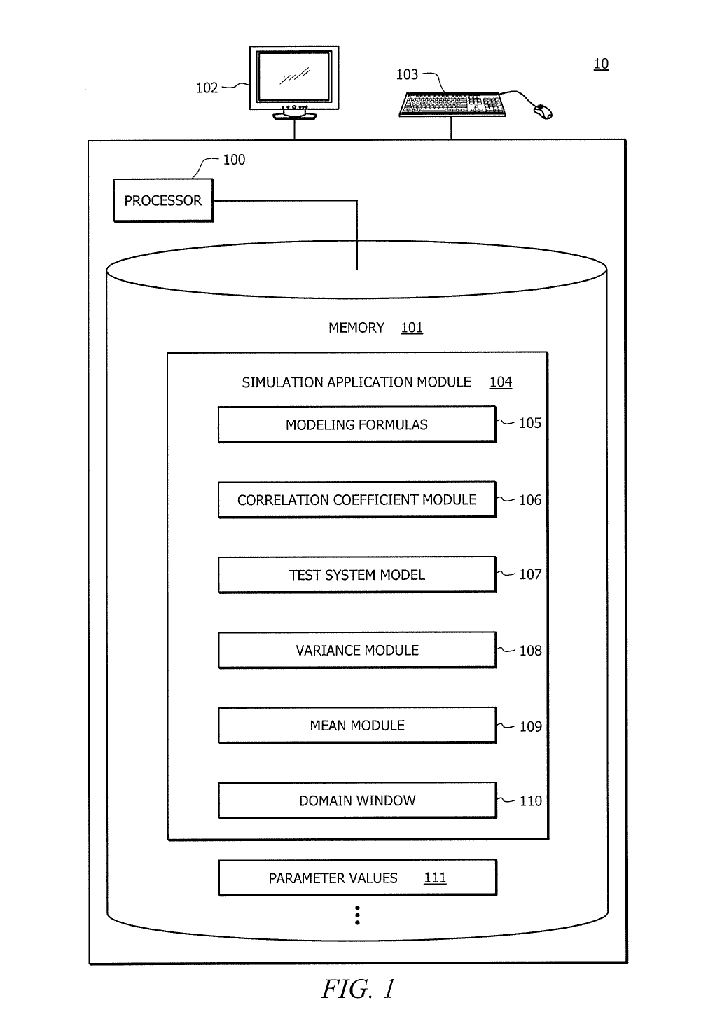

Turning now to FIG. 1, a block diagram illustrates computing system 10 configured according to one embodiment of the present disclosure. Computing system 10 includes processor 100, memory 101 coupled to processor 100, visual display 102, and input device 103. Simulation application module 104 is stored in memory 101. When executed by processor 100, simulation application module 104 creates a simulation environment in which a test system may be simulated for observation of various subjects of interest. For example, in the previous example describing simulation of the interaction of electromagnetic waves from a cell phone with a human head, the subjects of interest may be the magnitude of the electric and magnetic fields. In the simulation of fluid flow through a porous geological formation, the subject of interest may be the magnitude of fluid pressure. Furthermore, in a simulation of earthquakes, the subject of interest may be the magnitude of the pressure waves.

Simulation application module 104 contains several different modules and elements that provide the information and means to simulate the underlying test system. Simulation application module 104 contains modeling formulas 105, which provide the mathematical formulas or algorithms used to calculate the value of the subjects of interest in the test system. It also includes test system model 107, which provides a mathematical representation of the test system. For example, referring again to the cell phone testing example, the test system is a physical area encompassing a cell phone positioned in close proximity to one of the ears on a human head. One of the methods for simulating this test system is using a time domain, grid-based model, such as the FDTD method. In this particular example test system, test system model 107 may include the mathematical representation of the physical area of the cell phone-head combination including the different attributes of each of the materials within the area and the division of the overall area into the individual small grid cells that will be used in the simulation with the FDTD method. In the earthquake simulation example, test system model 107 may include the mathematical representation of the area being simulated along with the representative attributes of the various soil layers, rock formation, and the like.

Domain window 110 includes the boundary points or test window for the simulation. In time domain simulations, domain window 110 may include the period of time and the incremental step value over which the simulation is to be run. In frequency domain simulations, domain window 110 may include the band of frequencies and the incremental frequency step value over which the simulation is to be run. For each such incremental step in the simulation process, the variance and mean are calculated for the subjects of interest. Variance module 108 and mean module 109 include the formulas to calculate the mean or average value of the subject of interest and the variance of the subject of interest for that particular simulation. Variance module 108 will use a correlation coefficient from correlation coefficient module 106 in order to calculate the variance. Each correlation coefficient corresponds to a particular subject of interest being tested. Correlation coefficient module 106 determines the correlation coefficient through any number of different ways. For example, correlation coefficient module 106 may analyze test system model 107 to determine the properties of the various features of the test system. For instance, in the cell phone-head simulation, the variability of tissue, head shape or size, ear size, and the like would indicate wave reflection coefficients that could be used to determine the correlation coefficient. In other implementations, a user may simply enter an estimated value through input device 103 or otherwise.

It should be noted that in some embodiments of the present disclosure, the correlation coefficients may be determined by correlation coefficient module 106 once, prior to the start of the simulation, with the same determined correlation coefficient being used for each simulation of the points in domain window 110. In additional or alternative embodiments of the present disclosure, correlation coefficient module 106 may re-determine the correlation coefficient for every incremental test point after each simulation. By re-determining the correlation coefficients for each incremental simulation, correlation coefficient 106 will account for any changes occurring throughout the test system as the simulation incrementally progresses through domain window 110.

As the simulation is begun, the simulation environment defined by execution of simulation application module 104 will populate the variables of modeling formulas 105 using parameter values 111. Parameter values 111 include the sets of statistical values for each of the variables in modeling formulas 105. The particular values selected by the simulation environment from parameter values 111 correspond to the conditions at the particular point within domain window 110. Using the defined parameter values, modeling formulas 105 are then used to calculate the value of the subjects of interest for that incremental point in domain window 110. Variance module 108 and mean module 109 then calculate the variance and mean of the subjects of interest for that incremental point. Once all calculations for that simulation are completed, the simulation environment stores the results in memory 101 and continues the next simulation for the next incremental point in domain window 110, again, selecting the appropriate new values from parameter values 111 for modeling formulas 105. The simulation environment continues this process until the simulation has run over all of domain window 110.

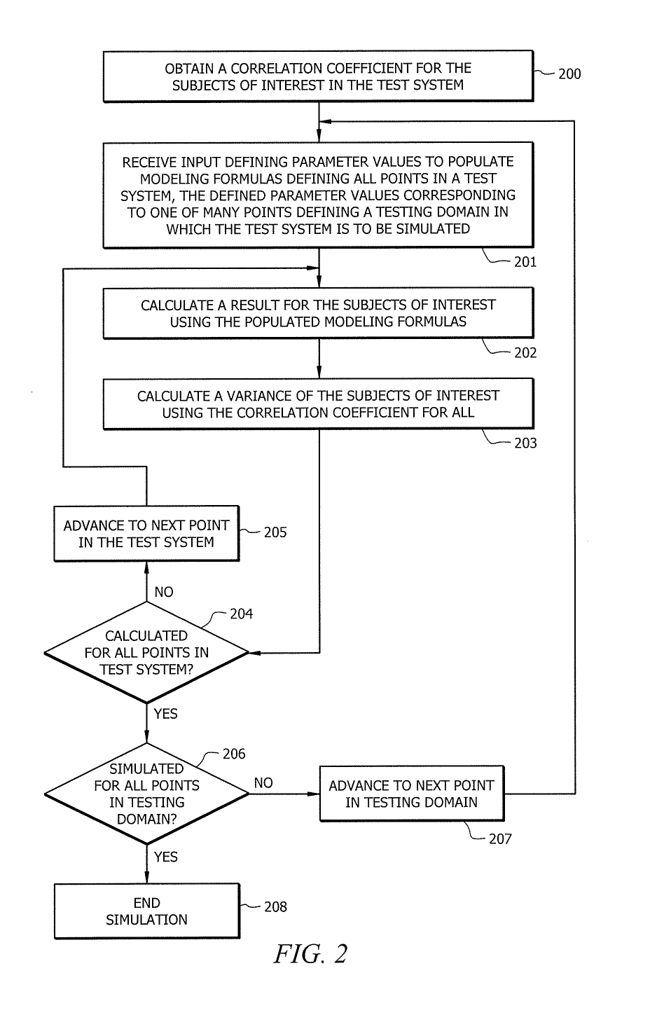

FIG. 2 is a functional block diagram illustrating example blocks executed to implement one embodiment of the present disclosure. In block 200, a correlation coefficient is obtained for the subjects of interest in the test system. Input, defining various parameters to populate into modeling formulas defining all points in the test system, is received, in block 201, where the parameter values correspond to the values defining all points in the test system for one of the many domain points defining a testing domain in which the test system is to be simulated. In block 202, a result for the subjects of interest is calculated using the populated modeling formulas. In block 203, a variance of the subjects of interest is calculated using at least the correlation coefficient. A determination is made, in block 204, whether the calculations of blocks 202 and 203 have been made for all points in the test system. If not, then, in block 205, the process is advanced to the next point in the test systems and repeated from block 202. If the calculations have been performed for all of the points in the test system, then, in block 206, a determination is made whether the simulation has been iterated through each of the domain points in the testing domain. If not, then, in block 207, the simulation is advanced to the next point in the domain where the process is repeated again from block 201. If the simulation has run through the entire domain, then, in block 208, the simulation of the test system is ended. As the simulation process measures the variance for each point in the test system for each domain point in the testing domain, the resulting solution of the simulation builds.

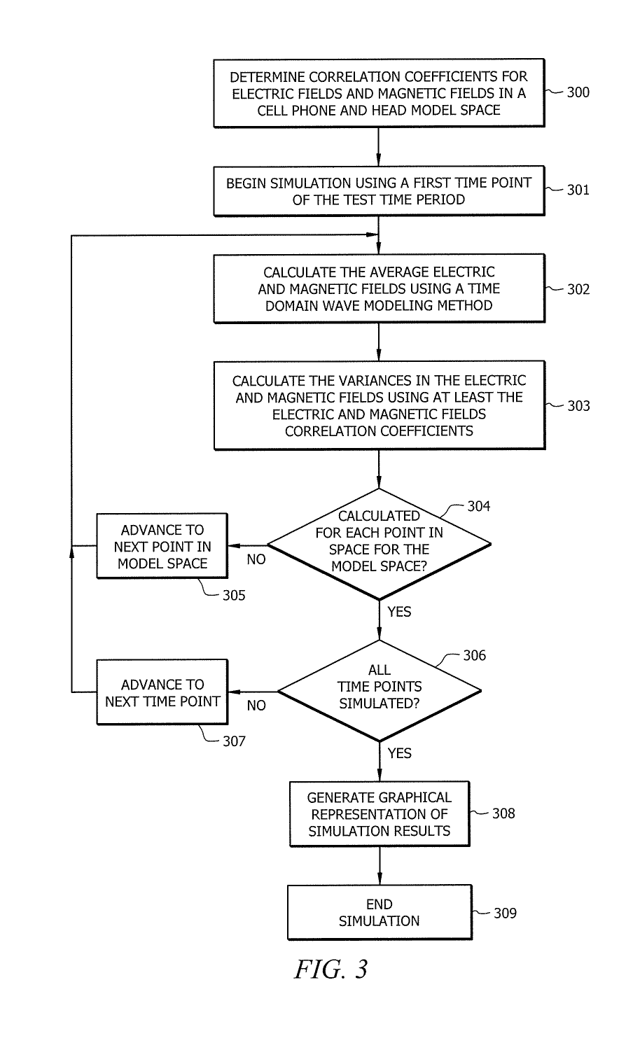

In one specific implementation of the present disclosure, the simulation of the cell phone-head analysis may be conducted. FIG. 3 is a functional block diagram illustrating example steps executed to implement one embodiment of the present disclosure directed to simulating the interaction of electromagnetic waves from a cell phone with a human head. In the example embodiments, the subjects of interest for this simulation are the electric field and the magnetic field throughout the system model. In block 300, correlation coefficients for the electric field and magnetic field are determined in the cell phone-head model space. In block 301, the simulation begins with a first time point of the test time period. In block 302, the average magnitudes of the electric and magnetic fields are calculated using a time domain wave modeling method. The variances in electric and magnetic fields magnitude are then calculated, in block 303, using at least the electric and magnetic field correlation coefficients. A determination is made, in block 304, whether the calculations of blocks 302 and 303 have been performed for each point in space within the model space. If not, then, in block 305, the process advances to the next point in space in the model space and repeated from block 302. If the calculations of blocks 302 and 303 have been performed for all of the points in the model space, then, in block 306, a determination is made whether the simulation has been completed for each of the time points in the simulation time period. If not, then, in block 307, the simulation is advanced to the next time point and repeated from block 302. If the simulation has run for all time points in the simulation time period, then, in block 308, a graphical representation of the simulation results is generated. This graphical representation may be stored in memory for future access by a user or may immediately be rendered to a display device for observation. In block 309, the simulation ends. Again, as the simulation process measures the variance for each point in space of the cell phone-head model space for each time point in the simulation time period, the resulting solution of the simulation builds.

The example implementation described with respect to FIG. 3 illustrates just one example embodiment of the present disclosure. In the described example, a cell phone electromagnetic energy absorption simulation analysis includes simulation solutions for two subjects of interest, electric fields and magnetic fields. However, the scope of the present disclosure is not limited to any specific implementation or subject of simulation analysis. Even within the example application of the various aspects of the present disclosure to the cell phone—head simulation, there may be only one subject of interest or even more than two. The following description provides much greater detail of a such an example application of the various aspects of the present disclosure to the same cell phone—head simulation, but in this alternative example, a system for analyzing one subject of interest.

I. Background of Simulations Using FDTD

A. Finite-Difference Time-Domain (FDTD)

The finite-difference time-domain (FDTD) method generally replaces Maxwell's differential equations with difference equations. FDTD does not require the use of linear algebra for its solution as does the Finite Element Method (FEM). FDTD models have been run with as many as 10⁹ field unknowns compared to the largest FEM simulation of about 10⁶ unknowns. The number of unknowns that can be simulated continually increases as the memory and computational capability of computers increases.

The FDTD method has many properties that give it advantages over other methods. It is useful for complex heterogeneous models, such as cell phone studies and has been used to model cell phones, as well as radar cross-section of entire aircraft, missiles, circuit boards, waveguides, as well as device packaging, and passive and active circuit components. It does not use linear algebra to solve a matrix equation (as FEM does), thus expanding the size of problems it can evaluate. The sources of numerical error are well understood for FDTD simulations. There are three sources of error with FDTD simulation: modeling errors, truncation errors, and round-off errors. The modeling errors are those that would be caused by the assumptions used in coming up with a mathematical model. Truncation errors have to do with Taylor series being truncated and the model space being divided up in increments of distance. One can use longer Taylor series expansions and divided the space into finer and finer increments but this would lead to more round-off errors. Round-off errors are due to the way numbers are represented in computers, these numbers have finite precision. But knowing about these types of errors, one can modify the size of steps, increase the precision of the computer simulation to use double precision, and use more terms of the Taylor series expansion of the original difference equations.

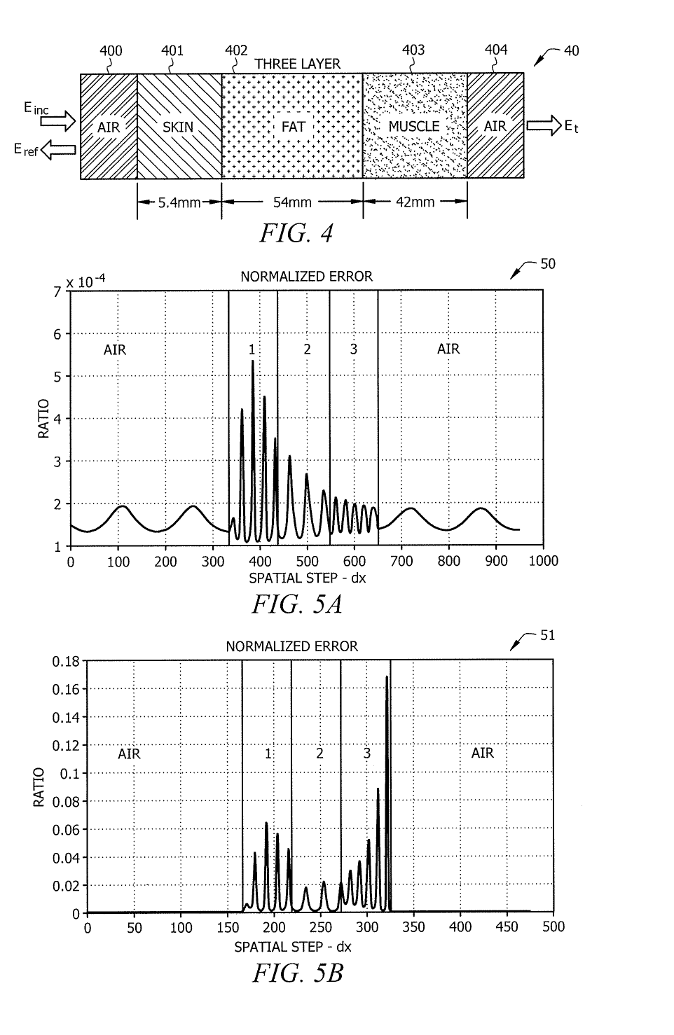

FDTD is considered a space grid time domain technique which is a direct solution method for Maxwell's differential curl equations. The region of the simulation is defined, and sources are modeled in the time domain. Antennas and other sources can be simulated close to or far from different objects, and both near and far field reactions can be analyzed. The interest here is the development of approximations to derive the mean and the variance without performing a Monte Carlo analysis, which takes a lot of simulation time. In the present disclosed detailed example, human tissue is modeled, in a very simplified three layer model (skin, fat, and muscle), as illustrated in FIG. 4.

B. Perturbation Theory

Perturbation theory is used to find an approximate solution to a problem that is very difficult to derive an exact solution. In the classical sense, it assumes that the solution has a Taylor series expansion that is truncated using only the first few terms. This truncated series is substituted into the equation that is being approximated, and the equation is expanded. The coefficients of the Taylor Series are then determined mathematically This method has been used in a number of problems before. This is one of the methods that is used in finding the stochastic properties of mechanical systems using FEM simulations.

In the sense that it is being used here, the stochastic function g(∈_{R},σ) is expanded in a Taylor Series (truncated) about the mean of the two random variables ∈_{R} (permittivity) and σ (conductance) the tissue properties, i.e., μ_{∈}_{ᵣ}, μ_{g}, and substituted back into the equation for the expectation E{g(∈_{R}, σ)} and that of the variance σ²{g(∈_{R}, σ)}. The equation for the variance {g(∈_{R}, σ)} is equal to E{g(∈_{R}, σ)²}−E{g(∈_{R}, σ)}². These equations are expanded using the Taylor Series Expansion, and higher order terms are discarded.

C. Detail—FDTD Equations

Beginning with Faraday's law (with Maxwell's correction) and Ampere's law:

$$\begin{matrix}∇ xE = - \frac{δ B}{δ t} & ( 1 ) \\ ∇ xH = \frac{δ D}{δ t} + σ E & ( 2 )\end{matrix}$$

For one dimensional TEM propagation in the z direction this simplifies to:

$$\frac{\partial {E}_{x}}{\partial z} = - \frac{\partial {B}_{y}}{\partial t} , - \frac{\partial {H}_{y}}{\partial z} = {ɛ}_{r} {ɛ}_{o} \frac{\partial {E}_{x}}{\partial t} + \underline{σ} {E}_{x} \qquad ( 3 )$$

They are then converted to their difference form yielding the following equations:

$$\begin{matrix}\frac{{B}_{y}^{n + 1 / 2} ( k + 1 / 2 ) - {B}_{y}^{n - 1 / 2} ( k + 1 / 2 )}{Δ t} = - \frac{( {E}_{x}^{n} ( k + 1 ) - {E}_{x}^{n} ( k ) )}{Δ z} & ( 4 ) \\ {E}_{x}^{n + 1} ( k ) - ( \frac{( \frac{{ɛ}_{r} {ɛ}_{o}}{Δ t} - \frac{\underline{σ}}{2} )}{( \frac{{ɛ}_{e} {ɛ}_{o}}{Δ t} + \frac{\underline{σ}}{2} )} ) {E}_{x}^{n} ( k ) = - \frac{[ {H}_{y}^{n + 1 / 2} ( k ) - {H}_{y}^{n + 1 / 2} ( k - 1 ) ]}{( \frac{{ɛ}_{r} {ɛ}_{o}}{Δ t} + \frac{\underline{σ}}{2} ) Δ z} & ( 5 )\end{matrix}$$

FIG. 4 is a block diagram illustrating test system model space 40 for simulation according to one embodiment of the present disclosure. Test system model space 40 includes three layers, skin 401, fat 402, and muscle 403, with air layers 400 and 404 on either side for purposes of the simulations. Equations (4) and (5) are implemented in a one-dimensional FDTD simulation of the three layer test system model space 40. The relative permittivity (∈ᵣ) and conductivity (σ) of each layer are assumed to have statistical variations that produce variations in absorbed power within the model. This code is used as the starting point for experimenting with different approximations of the statistical variability of the tissue.

D. Monte Carlo Analysis

The Monte Carlo Analysis repeatedly runs the same simulation over and over again changing the physical (stochastic variables) parameters of the human tissue at the beginning of each simulation. These parameters (i.e., ∈_{R},σ) are chosen randomly based upon their Gaussian statistics. Each simulation determines a sample of the stochastic model space. The simulations are accumulated (stored) to be post-processed to determine statistical averages of the E and H fields. Monte Carlo analysis uses thousands of runs to be made to get good statistical data. These simulations can take hours to perform (>5 hours for 10,000 simulations for the simple one-dimensional model given above).

II. DETERMINE STOCHASTIC FDTD EQUATIONS

A. Delta Method

1) Mean Approximation

In the approximations that will be disclosed with regard to this detailed example, Stochastic equations are used that contain six random variables. These namely are the E (electric) fields terms, H (magnetic) fields terms, relative permittivity (∈ᵣ), and the conductivity (σ). The symbol for the conductivity is sigma σ, and it has been changed to (σ) for clarity sake to allow the standard symbol for the variance terms.

The underlying process begins with the Taylor's Series expansion of a generic function which is referred to here as g(x₁, x₂, x₃, . . . , xₙ)=shown next.

$$g ( {x}_{1} , {x}_{2} , {x}_{3} , … , {x}_{n} ) = g ( {μ}_{{x}_{1}} , {μ}_{{x}_{2}} , {μ}_{{x}_{3}} , … , {μ}_{{x}_{n}} ) + {\sum }_{i = 1}^{n} \frac{\partial g}{\partial {x}_{i}} ] {( {x}_{i} - {μ}_{{x}_{i}} )}_{{μ}_{{x}_{1}} , {μ}_{{x}_{2}} , … , {μ}_{{x}_{n}}} + \frac{1}{2 !} {\sum }_{i = 1}^{n} {\sum }_{j = 1}^{n} \frac{{\partial }^{2} g}{\partial {x}_{i} \partial {x}_{j}} ] {( {x}_{i} - {μ}_{{x}_{i}} )}_{{μ}_{{x}_{1}} , {μ}_{{x}_{2}} , … , {μ}_{{x}_{n}}} ( {x}_{j} - {μ}_{{x}_{j}} ) + … \qquad ( 6 )$$

Taking the expectation of equation (6):

$$E \{ g ( {μ}_{{x}_{1}} , {μ}_{{x}_{2}} , {μ}_{{x}_{3}} , … , {μ}_{{x}_{n}} ) \} = E \{ g ( {μ}_{{x}_{1}} , {μ}_{{x}_{2}} , {μ}_{{x}_{3}} , … , {μ}_{{x}_{n}} ) + {\sum }_{i = 1}^{n} \frac{\partial g}{\partial {x}_{i}} ] {( {x}_{i} - {μ}_{{x}_{i}} )}_{{μ}_{{x}_{1}} , {μ}_{{x}_{2}} , … , {μ}_{{x}_{n}}} + \frac{1}{2 !} {\sum }_{i = 1}^{n} {\sum }_{j = 1}^{n} \frac{{\partial }^{2} g}{\partial {x}_{i} \partial {x}_{j}} ] {( {x}_{i} - {μ}_{{x}_{i}} )}_{{μ}_{{x}_{1}} , {μ}_{{x}_{2}} , … , {μ}_{{x}_{n}}} ( {x}_{j} - {μ}_{{x}_{j}} ) + … \} \qquad ( 7 )$$

Because the expectation is a linear operator, the brackets of the equation can be opened and the expectation operator applied to each term yielding the following equation:

$$E \{ g ( {μ}_{{x}_{1}} , {μ}_{{x}_{2}} , {μ}_{{x}_{3}} , … , {μ}_{{x}_{n}} ) \} = g ( {μ}_{{x}_{1}} , {μ}_{{x}_{2}} , {μ}_{{x}_{3}} , … , {μ}_{{x}_{n}} ) + E \{ {\sum }_{i = 1}^{n} \frac{\partial g}{\partial {x}_{i}} ] {( {x}_{i} - {μ}_{{x}_{i}} )}_{{μ}_{{x}_{1}} , {μ}_{{x}_{2}} , … , {μ}_{{x}_{n}}} \} + E \{ \frac{1}{2 !} {\sum }_{i = 1}^{n} {\sum }_{j = 1}^{n} \frac{{\partial }^{2} g}{\partial {x}_{i} \partial {x}_{j}} ] {( {x}_{i} - {μ}_{{x}_{i}} )}_{{μ}_{{x}_{1}} , {μ}_{{x}_{2}} , … , {μ}_{{x}_{n}}} ( {x}_{j} - {μ}_{{x}_{j}} ) \} + … \qquad ( 8 )$$

There are a number of terms in equation (8) that go to zero, such as the terms containing E{xᵢ, μₓ_{ᵢ}},E{xᵢ,μₓ_{ᵢ}}. For example, because the expectation operator is linear, these brackets can be opened yielding E{xᵢ−μₓ_{ᵢ}},E{xⱼ}−μₓ_{ⱼ} and the expectation of E{xᵢ}=μₓ_{ᵢ},E{xⱼ}−μₓ_{ⱼ}, with the expectation of a constant being a constant, therefore, these terms yield zero as their result. Simplifying the expression to an equation, remembering E{aX}=aE{X}, with a being a constant term, and allowing the constant term to be brought outside the expectation operator yields equation (9):

$$\begin{matrix}E \{ g ( {x}_{1} , {x}_{2} , {x}_{3} , … , {x}_{n} ) \} = g ( {μ}_{{x}_{1}} , {μ}_{{x}_{2}} , {μ}_{{x}_{3}} , … , {μ}_{{x}_{n}} ) & ( 9 ) \\ \overbrace{{\sum }_{i = 1}^{n} \frac{\partial g}{\partial {x}_{i}} ] {E \{ ( {x}_{i} - {μ}_{{x}_{i}} ) \}}_{{μ}_{{x}_{1}} , {μ}_{{x}_{2}} , … , {μ}_{{x}_{n}}}}^{0} + \frac{1}{2 !} {\sum }_{i = 1}^{n} {\sum }_{j = 1}^{n} \frac{{\partial }^{2} g}{\partial {x}_{i} \partial {x}_{j}} ] {E \{ ( {x}_{i} - {μ}_{{x}_{i}} )}_{{μ}_{{x}_{1}} , {μ}_{{x}_{2}} , … , {μ}_{{x}_{n}}} ( {x}_{j} - {μ}_{{x}_{j}} ) \} + … & ( 10 )\end{matrix}$$

neglecting high order terms reduces equation (10) even further to

E{g(x₁,x₂,x₃, . . . ,xₙ)}≈g(μₓ_{₁},μₓ_{₂},μₓ_{₃}, . . . ,μₓ_{ₙ}) (11)

which is the desired approximation that will be used for the mean of the Stochastic equation.

2) Variance Approximation

Using the same procedure as previously presented and the following identity for the Variance,

σ²{g(x₁,x₂,x₃, . . . ,xₙ)}=E{g(x₁,x₂,x₃, . . . ,xₙ)²}−E{g(x₁,x₂,x₃, . . . ,xₙ)}² (12)

Equation (12) is then expanded in a Taylor's Series about the mean of each of the stochastic variables which yields:

$${σ}^{2} \{ g ( {x}_{1} , {x}_{2} , {x}_{3} , … , {x}_{n} ) \} = {\sum }_{i = 1}^{n} {\sum }_{j = 1}^{n} \frac{\partial g}{\partial {x}_{i}} \frac{{\partial }^{2} g}{\partial {x}_{j}} ] {E \{ ( {x}_{i} - {μ}_{{x}_{i}} )}_{{μ}_{{x}_{1}} , {μ}_{{x}_{2}} , … , {μ}_{{x}_{n}}} ( {x}_{j} - {μ}_{{x}_{j}} ) \} + … \qquad ( 13 )$$

Removing higher order terms from equation (13) results in the variance of g(x₁, x₂, x₃, . . . , xₙ) expanded about the mean of the random variables being approximately equal to:

$${\sum }_{i = 1}^{n} {\sum }_{j = 1}^{n} \frac{\partial g}{\partial {x}_{i}} \frac{\partial g}{\partial {x}_{j}} ] {E \{ ( {x}_{i} -}_{{μ}_{{x}_{1}} , {μ}_{{x}_{2}} , … , {u}_{xn}} {μ}_{{x}_{i}} ) ( {x}_{j} - {μ}_{{x}_{j}} ) \} \qquad ( 14 )$$

B. Mean Approximation

Using the expectation operator on the FDTD equations, the mean of both B_{y}^{n+1/2}(k) and E_{y}ⁿ⁺¹(k) are analytically determined. Taking the mean of both sides of Faraday's and Ampere's difference equations (4) and (5) yields the following:

$$\begin{matrix} E \{ {B}_{y}^{n + 1 / 2} ( k ) - {B}_{y}^{n - 1 / 2} ( k ) \} = E \{ - \frac{Δ t}{Δ z} [ {E}_{x}^{n} ( k + 1 ) - {E}_{x}^{n} ( k ) ] \} & ( 15 ) \\ E \{ {E}_{x}^{n + 1} ( k ) - ( \frac{\frac{{ɛ}_{r} {ɛ}_{o}}{Δ t} - \frac{\underline{σ}}{2}}{\frac{{ɛ}_{r} {ɛ}_{o}}{Δ t} + \frac{\underline{σ}}{2}} ) {E}_{x}^{n} ( k ) \} = E \{ - \frac{{H}_{y}^{n + 1 / 2} ( k ) - {H}_{y}^{n + 1 / 2} ( k - 1 )}{\{ \frac{{ɛ}_{r} {ɛ}_{o}}{Δ t} + \frac{\underline{σ}}{2} \} Δ z} \} & ( 16 )\end{matrix}$$

Because the expectation is a linear operator (E{aX+bY} is equal to aE{X}+bE{Y} with a and b being constant), the brackets on the left side of each equation can be opened and the expectation operator applied to each term. The first equation, B_{y}^{n+1/2}(k), is very easy to expand with the expectation operator. Leaving each term in a form well suited for FDTD simulation yields:

$$E \{ {B}_{y}^{n + 1 / 2} ( k ) \} = E \{ {B}_{y}^{n - 1 / 2} ( k ) \} - \frac{Δ t}{Δ z} [ E \{ {E}_{x}^{n} ( k + 1 ) \} - E \{ {E}_{x}^{n} ( k ) \} ] \qquad ( 17 )$$

Equation (17) is Faraday's mean equation.

Ampere's equation is not as easily separated, as can be seen from the following equation:

$$E \{ {E}_{x}^{n + 1} ( k ) \} - E \{ ( \frac{\frac{{ɛ}_{r} {ɛ}_{o}}{Δ t} - \frac{\underline{σ}}{2}}{\frac{{ɛ}_{r} {ɛ}_{o}}{Δ t} + \frac{\underline{σ}}{2}} ) {E}_{x}^{n} ( k ) \} = - \frac{1}{Δ z} E \{ \frac{{H}_{y}^{n + 1 / 2} ( k ) - {H}_{y}^{n + 1 / 2} ( k - 1 )}{\{ \frac{{ɛ}_{r} {ɛ}_{o}}{Δ t} + \frac{\underline{σ}}{2} \}} \} \qquad ( 18 )$$

This function is difficult to separate Eₓⁿ(k) from (∈ᵣ) or (σ), because these two random variables randomize Eₓⁿ(k).

The above equation shows that Eₓⁿ(k) (stochastic function of the form g (X,Y)) is a multi-variable function. An approximation to this function, E{Eₓⁿ⁺¹(k)[∈ᵣσ]}, using the previously derived equation (11) yields Eₓⁿ⁺¹(k)[E{∈ᵣ},E{σ}]. Substituting the expectations of both E{∈ᵣ} and E{σ} results in the following:

$$E \{ {E}_{x}^{n + 1} ( k ) \} = ( \frac{\frac{E \{ {ɛ}_{r} \} {ɛ}_{o}}{Δ t} - \frac{E \{ \underline{σ} \}}{2}}{\frac{E \{ {ɛ}_{r} \} {ɛ}_{o}}{Δ t} + \frac{E \{ \underline{σ} \}}{2}} ) E \{ {E}_{x}^{n} ( k ) \} - \frac{E \{ {H}_{y}^{n + 1 / 2} ( k ) \} - E \{ {H}_{y}^{n + 1 / 2} ( k - 1 ) \}}{Δ z \{ \frac{E \{ {ɛ}_{r} \} {ɛ}_{o}}{Δ t} + \frac{E \{ \underline{σ} \}}{2} \}} \qquad ( 19 )$$

Equation (19) is Ampere's mean equation. This is the original FDTD equation using the mean of each physical parameter of each layer. This seems reasonable given that one would assume that the mean E field would occur using the mean of the random parameters for each layer that is used in the simulation.

C. Variance Approximation

The variance of each of the two FDTD equations is determined next. In deriving these equations, the time and spatial coordinates are maintained and a number of identities are used, namely the variance of the sum of random variables and the multiplication of the random variable by a constant:

σ²[X±Y]=σ_{X}²+σ_{Y}²±2Cov(X,Y) (20)

σ²{aX}=a²σ²{X} (21)

where a is constant, and the Covariance identity is:

Cov(X,Y)=ρ_{XY}σ{X}σ{Y} (22)

To maintain the time and spatial coordinates, the finite difference equations are used in the following form prior to taking the variance of both sides of each equation, i.e., Faraday's and Ampere's equations:

$$\begin{matrix} {B}_{y}^{n + 1 / 2} ( k + 1 / 2 ) - {B}_{y}^{n - 1 / 2} ( k + 1 / 2 ) = - \frac{Δ t}{Δ z} ( {E}_{x}^{n} ( k + 1 ) - {E}_{x}^{n} ( k ) ) & ( 23 ) \\ {E}_{x}^{n + 1} ( k ) - ( \frac{( \frac{{ɛ}_{r} {ɛ}_{o}}{Δ t} - \frac{\underline{σ}}{2} )}{\frac{{ɛ}_{r} {ɛ}_{o}}{Δ t} + \frac{\underline{σ}}{2}} ) {E}_{x}^{n} ( k ) = - \frac{[ {H}_{y}^{n + 1 / 2} ( k ) - {H}_{y}^{n + 1 / 2} ( k - 1 ) ]}{( \frac{{ɛ}_{r} {ɛ}_{o}}{Δ t} + \frac{\underline{σ}}{2} ) Δ z} & ( 24 )\end{matrix}$$

1) Faraday's Equation

Taking the variance of the first of these equations yields:

$${σ}^{2} \{ {B}_{y}^{n + 1 / 2} ( k + 1 / 2 ) - {B}_{y}^{n - 1 / 2} ( k + 1 / 2 ) \} = \frac{Δ {t}^{2}}{Δ {z}^{2}} {σ}^{2} \{ {E}_{x}^{n} ( k + 1 ) - {E}_{x}^{n} ( k ) \} \qquad ( 25 )$$

After some manipulation, equation (25) becomes:

$${σ}^{2} \{ {B}_{y}^{n + 1 / 2} ( k + 1 / 2 ) \} + {σ}^{2} \{ {B}_{y}^{n - 1 / 2} ( k + 1 / 2 ) \} - 2 {ρ}_{{B}_{n + 1 / 2} , {B}_{n - 1 / 2}} σ \{ {B}_{y}^{n + 1 / 2} ( k + 1 / 2 ) \} σ \{ {B}_{y}^{n - 1 / 2} ( k + 1 / 2 ) \} = \frac{Δ {t}^{2}}{Δ {z}^{2}} ( {σ}^{2} \{ {E}_{x}^{n} ( k + 1 ) \} + {σ}^{2} \{ {E}_{x}^{n} ( k ) \} - 2 {ρ}_{{E}_{k + 1} , {E}_{k}} σ \{ {E}_{x}^{n} ( k + 1 ) \} σ \{ {E}_{x}^{n} ( k ) \} ) \qquad ( 26 )$$

From Monte Carlo Analysis the correlation coefficients in the preceding equation, i.e., ρ_{B}_{_{n+1/2}}_{,B}_{_{n−1/2}} and ρ_{E}_{ₖ₊₁}_{,E}_{ₖ}, can be approximated (to a first order) by 1.

FIG. 5A is a graphical plot illustrating example normalized error 50 in a simulation according to one embodiment of the present disclosure. FIG. 5A illustrates the normalized error, of assuming a correlation coefficient of the time derivative terms equal to one, on the order of 5×10⁻⁴ for a three layer dielectric model space. The spatial derivatives' correlation coefficients are more error prone. They are small but not as small as the time derivative terms.

FIG. 5B is a graphical plot illustrating another example normalized error 51 in a simulation according to one embodiment of the present disclosure. FIG. 5B illustrates the normalized error, of assuming a correlation coefficient of the time derivative terms equal to one, on the order of 0.18. It can be seen from this that the discretization of the model space would affect accuracy.

Using this approximation for the correlation coefficients (equal to one) the following equation is achieved, with some rearranging of terms.

$${σ}^{2} \{ {B}_{y}^{n + 1 / 2} ( k + 1 / 2 ) \} - 2 σ \{ {B}_{y}^{n + 1 / 2} ( k + 1 / 2 ) \} σ \{ {B}_{y}^{n - 1 / 2} ( k + 1 / 2 ) \} + {σ}^{2} \{ {B}_{y}^{n - 1 / 2} ( k + 1 / 2 ) ) \} = \frac{Δ {t}^{2}}{Δ {z}^{2}} ( {σ}^{2} \{ {E}_{x}^{n} ( k + 1 ) \} - 2 σ \{ {E}_{x}^{n} ( k + 1 ) \} σ \{ {E}_{x}^{n} ( k ) \} + {σ}^{2} \{ {E}_{x}^{n} ( k ) \} ) \qquad ( 27 )$$

Equation (27) shows that the proper timing and spatial coordinates have been maintained with the covariance term yielding a geometric mean of the terms involved. Equation (27) also illustrates that the terms on both sides of the equation are perfect squares. Placing these equations into their proper squared form yields:

$${( σ \{ {B}_{y}^{n + 1 / 2} ( k + 1 / 2 ) \} - σ \{ {B}_{y}^{n - 1 / 2} ( k + 1 / 2 ) \} )}^{2} = \frac{Δ {t}^{2}}{Δ {z}^{2}} {( σ \{ {E}_{x}^{n} ( k + 1 ) \} - σ \{ {E}_{x}^{n} ( k ) \} )}^{2} \qquad ( 28 )$$

Taking the square-root of each side, of equation (29), allows the variance-wave to build and self-limit. It also allows the use of standard boundary conditions to be used at model space boundaries.

$$σ \{ {B}_{y}^{n + 1 / 2} ( k + 1 / 2 ) \} - σ \{ {B}_{y}^{n - 1 / 2} ( k + 1 / 2 ) \} = \frac{Δ t}{Δ z} ( σ \{ {E}_{x}^{n} ( k + 1 ) \} - σ \{ {E}_{x}^{n} ( k ) \} ) \qquad ( 29 )$$

Solving for σ{B_{y}^{n+1/2}(k+1/2)} yields:

$$σ \{ {B}_{y}^{n + 1 / 2} ( k + 1 / 2 ) \} = σ \{ {B}_{y}^{n - 1 / 2} ( k + 1 / 2 ) \} + \frac{Δ t}{Δ z} ( σ \{ {E}_{x}^{n} ( k + 1 ) \} - σ \{ {E}_{x}^{n} ( k ) \} ) \qquad ( 30 )$$

Equation (30) is Faraday's variance equation

2) Ampere's Equation

Following the same procedure for Ampere's equation yields:

$$σ \{ {E}_{x}^{n + 1} ( k ) \} - σ \{ \frac{\frac{{ɛ}_{r} {ɛ}_{o}}{Δ t} - \frac{\underline{σ}}{2}}{\frac{{ɛ}_{r} {ɛ}_{o}}{Δ t} + \frac{\underline{σ}}{2}} {E}_{x}^{n} ( k ) \} \approx σ \{ \frac{- 1}{( \frac{{ɛ}_{r} {ɛ}_{o}}{Δ t} + \frac{\underline{σ}}{2} ) Δ z} ( {H}_{y}^{n + 1 / 2} ( k ) - {H}_{y}^{n + 1 / 2} ( k - 1 ) ) \} \qquad ( 31 )$$

Again, the compound terms cannot be separated except by the Delta approximation found in equation (14) repeated here

$${{\sum }_{i = 1}^{n} {\sum }_{j = 1}^{n} \frac{\partial g}{\partial {x}_{i}} \frac{\partial g}{\partial {x}_{j}} ]}_{{μ}_{{x}_{1}} , {μ}_{{x}_{2}} , … , {μ}_{{x}_{n}}} E \{ ( {x}_{i} - {μ}_{{x}_{i}} ) ( {x}_{j} - {μ}_{{x}_{j}} ) \} \qquad ( 14 )$$

After much manipulation, and solving for σ{Eₓⁿ⁺¹(k)} yields:

$$σ \{ {E}_{x}^{n + 1} ( k ) \} \approx \frac{2 {ɛ}_{o} {μ}_{{ɛ}_{r}} - Δ t {μ}_{\underline{σ}}}{2 {ɛ}_{o} {μ}_{{ɛ}_{r}} - Δ t {μ}_{\underline{σ}}} σ \{ {E}_{x}^{n} ( k ) \} + \frac{2 Δ t}{Δ x ( 2 {ɛ}_{o} {μ}_{{ɛ}_{r}} + Δ t {μ}_{\underline{σ}} )} ( σ \{ {H}_{y}^{n + 1 / 2} ( k + 1 / 2 ) \} - σ \{ {H}_{y}^{n + 1 / 2} ( k - 1 / 2 ) \} ) + \frac{4 Δ t {ɛ}_{o} ( {μ}_{\underline{σ}} {ρ}_{{ɛ}_{r} , E} σ \{ {ɛ}_{r} \} - {μ}_{{ɛ}_{r}} {ρ}_{\underline{σ} , E} σ \{ \underline{σ} \} )}{{( 2 {ɛ}_{o} {μ}_{{ɛ}_{r}} + Δ t {μ}_{\underline{σ}} )}^{2}} {E}_{x}^{n} ( k ) - \frac{2 Δ t}{Δ x ( 2 {ɛ}_{o} {μ}_{{ɛ}_{r}} + Δ t {μ}_{\underline{σ}} )} \\ ( \frac{( 2 {ɛ}_{o} σ \{ {ɛ}_{r} \} {ρ}_{{ɛ}_{r} , {H}_{y}^{n + 1 / 2}} + Δ t σ \{ \underline{σ} \} {ρ}_{\underline{σ} , {H}_{y}^{n + 1 / 2}} )}{( 2 {ɛ}_{o} {μ}_{{ɛ}_{r}} + Δ t {μ}_{\underline{σ}} )} ( {H}_{y}^{n + 1 / 2} ( k - 1 / 2 ) - {H}_{y}^{n + 1 / 2} ( k + 1 / 2 ) ) ) \qquad ( 32 )$$

Equation (32) is Ampere's variance equation.

Equation (32) is an approximation of the variance-wave for Ampere's Law. This equation includes standard deviation terms and the fields terms of both the E and H fields. The field terms supply the source for the stochastic FDTD equation which come from the simultaneous simulation of mean FDTD approximations. It should be noted that the field terms in equation (32), E and H, are mean valued (because each of these terms are evaluated at the mean of each of the random variables). With the two equations, equation (30) and equation (32), a variance wave can be generated yielding an approximation to the variance of the E-fields propagating through test system model space 40 (FIG. 4).

It should be noted that the multiple examples described herein with regard to the biological simulation analysis of electromagnetic energy absorption by a human head from a cell phone are not intended to limit the present disclosure to only a single application. The various aspects and embodiments of the present disclosure have multiple applications and potential implementation beyond such simulations.

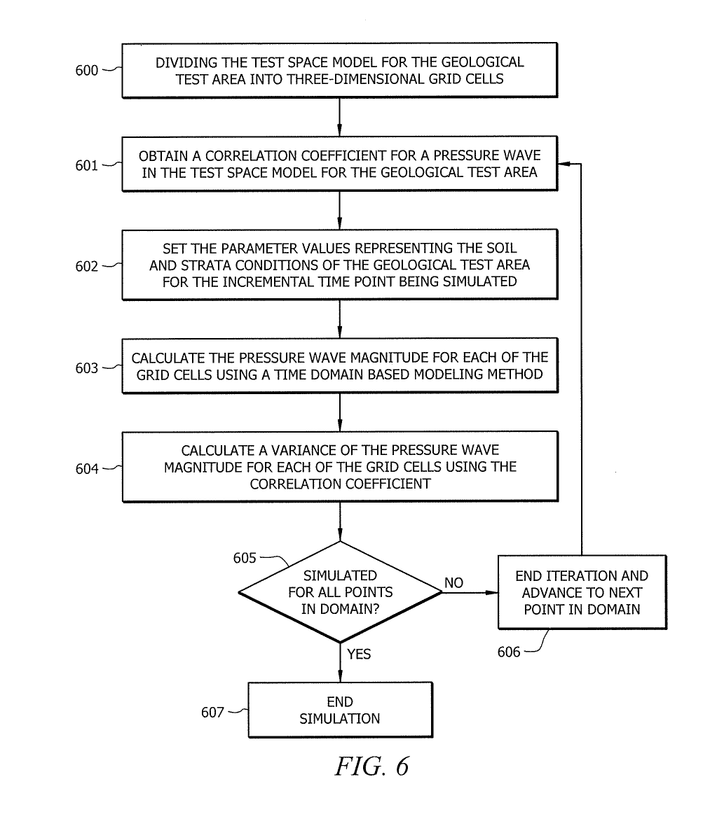

FIG. 6 is a functional block diagram illustrating example blocks executed to implement one embodiment of the present disclosure. The embodiment illustrated in FIG. 6 represents a simulation analysis conducted for the interaction of pressure waves caused by an earthquake on a particular geological test area having statistically variable soil and strata conditions. In block 600, the test space model for the geological test area is divided into three-dimensional grid cells. A correlation coefficient is obtained, in block 601, for pressure waves in the test space model for the geological test area. In block 602, the parameter values representing the soil and strata conditions of the geological test area for the incremental time point of the test period being simulated are set. The pressure wave magnitude is calculated, in block 603, for each of the grid cells using a time domain based modeling method. The variance of the pressure wave magnitude is then calculated, in block 604, for each of the grid cells using the correlation coefficient. In block 605, a determination is made whether all time points of the simulation time have been simulated. If not, then, in block 606, the simulation is advanced to the next time point, and the process is repeated beginning again from block 601, for obtaining a new correlation coefficient. If all of the time points of the simulation time have been tested, then, in block 607, the simulation is ended.

It should be noted that various post-processing may be applied to any of the disclosed implementations and examples in order to graphically present the simulation results for analysis or for further investigation. These post-processing elements do not affect the intended scope of the various embodiments of the present disclosure.

Embodiments, or portions thereof, may be embodied in program or code segments operable upon a processor-based system (e.g., computer system or computing platform) for performing functions and operations as described herein. The program or code segments making up the various embodiments may be stored in a computer-readable medium, which may comprise any suitable medium for temporarily or permanently storing such code. Examples of the computer-readable medium include such tangible computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

Embodiments, or portions thereof, may be embodied in a computer data signal, which may be in any suitable form for communication over a transmission medium such that it is readable for execution by a functional device (e.g., processor) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, a local area network (LAN), a metropolitan area network (MAN), a wide area network (WAN), the public switched telephone network (PSTN), a satellite communication system, a cable transmission system, and/or the like.

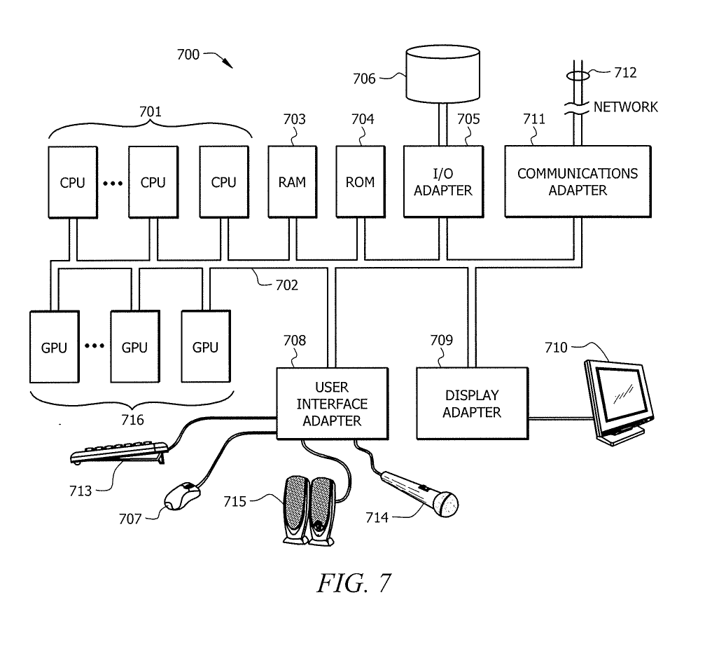

FIG. 7 illustrates an exemplary computer system 700 which may be employed to implement the various aspects and embodiments of the present disclosure. Central processing unit (“CPU” or “processor”) 701 is coupled to system bus 702. CPU 701 may be any general-purpose processor. The present disclosure is not restricted by the architecture of CPU 701 (or other components of exemplary system 700) as long as CPU 701 (and other components of system 700) supports the inventive operations as described herein. As such CPU 701 may provide processing to system 700 through one or more processors or processor cores. CPU 701 may execute the various logical instructions described herein. For example, CPU 701 may execute machine-level instructions according to the exemplary operational flow described above in conjunction with FIGS. 2, 3, and 6. When executing instructions representative of the operational steps illustrated in FIGS. 2, 3, and 6, CPU 701 becomes a special-purpose processor of a special purpose computing platform configured specifically to operate according to the various embodiments of the teachings described herein.

Computer system 700 also includes random access memory (RAM) 703, which may be SRAM, DRAM, SDRAM, or the like. Computer system 700 includes read-only memory (ROM) 704 which may be PROM, EPROM, EEPROM, or the like. RAM 703 and ROM 704 hold user and system data and programs, as is well known in the art.

Computer system 700 also includes input/output (I/O) adapter 705, communications adapter 711, user interface adapter 708, and display adapter 709. I/O adapter 705, user interface adapter 708, and/or communications adapter 711 may, in certain embodiments, enable a user to interact with computer system 700 in order to input information.

I/O adapter 705 connects to storage device(s) 706, such as one or more of hard drive, compact disc (CD) drive, floppy disk drive, tape drive, etc., to computer system 700. The storage devices are utilized in addition to RAM 703 for the memory requirements of the various embodiments of the present disclosure. Communications adapter 711 is adapted to couple computer system 700 to network 712, which may enable information to be input to and/or output from system 700 via such network 712 (e.g., the Internet or other wide-area network, a local-area network, a public or private switched telephony network, a wireless network, any combination of the foregoing). User interface adapter 708 couples user input devices, such as keyboard 713, pointing device 707, and microphone 714 and/or output devices, such as speaker(s) 715 to computer system 700. Display adapter 709 is driven by CPU 701 and/or by graphical processing unit (GPU) 716 to control the display on display device 710 to, for example, present the results of the simulation. GPU 716 may be any various number of processors dedicated to graphics processing and, as illustrated, may be made up of one or more individual graphical processors. GPU 716 processes the graphical instructions and transmits those instructions to display adapter 709. Display adapter 709 further transmits those instructions for transforming or manipulating the state of the various numbers of pixels used by display device 710 to visually present the desired information to a user. Such instructions include instructions for changing state from on to off, setting a particular color, intensity, duration, or the like. Each such instruction makes up the rendering instructions that control how and what is displayed on display device 710.

It shall be appreciated that the present disclosure is not limited to the architecture of system 700. For example, any suitable processor-based device may be utilized for implementing the various embodiments of the present disclosure, including without limitation personal computers, laptop computers, computer workstations, multi-processor servers, and even mobile telephones. Moreover, certain embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of simulating a test system in a computing device, said method comprising:
executing, by a processor, a simulation application stored on a memory coupled to said processor, said executing simulation application presenting a simulation environment in said computing device;
receiving input defining one or more parameter values for populating one or more modeling formulas defining said test system, said one or more defined parameter values corresponding to one of a plurality of points defining a domain in which said test system is to be simulated;
obtaining a correlation coefficient for one or more subjects of interest in said test system;
calculating a result for said one or more subjects of interest using said populated one or more modeling formulas;
calculating a variance of said one or more subjects of interest using at least said correlation coefficient; and
repeating said receiving, said calculating said result, and said calculating said variance for each subsequent point of said plurality of points.

2. The method of claim 1 further comprising:
calculating an average value of said one or more subjects of interest, wherein said repeating further comprises repeating said calculating said average value.

3. The method of claim 1 wherein said obtaining said correlation coefficient comprises:
analyzing a model space of said test system; and
determining said correlation coefficient based on said analyzing.

4. The method of claim 1 wherein said obtaining said correlation coefficient comprises receiving assignment of an estimated value for said correlation coefficient.

5. The method of claim 1 wherein said domain is one of: a time domain and a frequency domain.

6. The method of claim 1 wherein said one or more parameter values is defined based on a set of alternative statistical values of said one or more parameter values.

7. The method of claim 1 wherein said repeating further comprises repeating said obtaining said correlation coefficient.

8. A computer program product to simulate a test system in a computing device, comprising:
a computer-readable medium having program code recorded thereon, said program code comprising:
program code to establish a simulation environment in said computing device;
program code to receive input defining one or more parameter values for populating one or more modeling formulas defining said test system, said one or more defined parameter values corresponding to one of a plurality of points defining a domain in which said test system is to be simulated;
program code to obtain a correlation coefficient for one or more subjects of interest in said test system;
program code to calculate a result for said one or more subjects of interest using said populated one or more modeling formulas;
program code to calculate a variance of said one or more subjects of interest using at least said correlation coefficient; and
program code to repeat execution of said program code to receive, said program code to calculate said result, and said program code to calculate said variance for each subsequent point of said plurality of points.

9. The computer program product of claim 8 said program code further comprising:
program code to calculate an average value of said one or more subjects of interest, wherein said program code to repeat further comprises program code to repeat execution of said program code to calculate said average value.

10. The computer program product of claim 8 wherein said program code to obtain said correlation coefficient comprises:
program code to analyze a model space of said test system; and
program code to determine said correlation coefficient based on results of said program code to analyze.

11. The computer program product of claim 8 wherein said program code to obtain said correlation coefficient comprises program code to receive assignment of an estimated value for said correlation coefficient.

12. The computer program product of claim 8 wherein said domain is one of: a time domain and a frequency domain.

13. The computer program product of claim 8 wherein said one or more parameter values is defined based on a set of alternative statistical values of said one or more parameter values.

14. The computer program product of claim 8 wherein said program code to repeat further comprises program code to repeat execution of said program code to obtain said correlation coefficient.

15. A computing device configured to simulate a test system, said computing device comprising:
at least one processor; and
a memory coupled to said at least one processor,
wherein said at least one processor is configured to:
execute a simulation application stored on said memory, said executing simulation application generating a simulation environment in said computing device;
receive input defining one or more parameter values for populating one or more modeling formulas defining said test system, said one or more defined parameter values corresponding to one of a plurality of points defining a domain in which said test system is to be simulated;
obtain a correlation coefficient for one or more subjects of interest in said test system;
calculate a result for said one or more subjects of interest using said populated one or more modeling formulas;
calculate a variance of said one or more subjects of interest using at least said correlation coefficient; and
repeat said receiving, said calculating said result, and said calculating said variance for each subsequent point of said plurality of points.

16. The computing device of claim 15 wherein said at least one processor is further configured to:
calculate an average value of said one or more subjects of interest, wherein said at least one processor configured to repeat is further configured to repeat said calculating said average value.

17. The computing device of claim 15 wherein said at least one processor configured to obtain said correlation coefficient is configured to:
analyze a model space of said test system; and
determine said correlation coefficient based on said analyzing.

18. The computing device of claim 15 wherein said at least one processor configured to obtain said correlation coefficient is configured to receive assignment of an estimated value for said correlation coefficient.

19. The computing device of claim 15 wherein said domain is one of: a time domain and a frequency domain.

20. The computing device of claim 15 wherein said one or more parameter values is defined based on a set of alternative statistical values of said one or more parameter values.

21. The computing device of claim 15 wherein said at least one processor configured to repeat is further configured to repeat said obtaining said correlation coefficient.
